(19) United States
(12) Patent Application Publication
(10) Pub. No.: US 2014/0187111 A1
(43) Pub. Date: Jul. 3, 2014

(54) COMPOSITE SHEET AND DISPLAY SUBSTRATE USING SAME

(71) Applicants: Young Kwon Kim, Uiwang-si (KR); Sang Keol Lee, Uiwang-si (KR); Eun Hwan Jeong, Uiwang-si (KR); Sung Kook Kim, Uiwang-si (KR); Hyun Ae Jeon, Ansan-si (KR); Yun Joo Kim, Ansan-si (KR); Sang Yong Tak, Ansan-si (KR); Suk Yeon Park, Ansan-si (KR); Kyung Nam Kang, Ansan-si (KR); So Young Kang, Ansan-si (KR)

(72) Inventors: Young Kwon Kim, Uiwang-si (KR); Sang Keol Lee, Uiwang-si (KR); Eun Hwan Jeong, Uiwang-si (KR); Sung Kook Kim, Uiwang-si (KR); Hyun Ae Jeon, Ansan-si (KR); Yun Joo Kim, Ansan-si (KR); Sang Yong Tak, Ansan-si (KR); Suk Yeon Park, Ansan-si (KR); Kyung Nam Kang, Ansan-si (KR); So Young Kang, Ansan-si (KR)

(21) Appl. No.: 14/116,966

(22) PCT Filed: May 8, 2012
(86) PCT No.: PCT/KR2012/003575

§ 371 Date: Jan. 27, 2014

(30) Foreign Application Priority Data
May 12, 2011 (KR) 10-2011-0044647

(51) Int. Cl. C08K 3/40; D06M 15/273

(52) U.S. Cl. CPC C08K 3/40; D06M 15/273
USPC 442/1; 442/180; 524/853; 252/182.14; 549/510

(57) ABSTRACT

A composite sheet of the present invention comprises an oxetane-(meth)acrylate compound, represented by chemical formula I, as a binder.

### TECHNICAL FIELD

The present invention relates to a composite sheet and a display substrate using the same. More particularly, the present invention relates to a composite sheet, which includes an oxetane-(meth)acrylate compound having a specific structure as a binder to provide excellent flexibility while securing excellent properties in terms of heat resistance, optical properties and processibility, and a display substrate using the same.

### BACKGROUND ART

A glass substrate having excellent thermal resistance, transparency and a low coefficient of linear expansion has been widely used as a substrate for liquid crystal display devices, organic EL display devices, color filters, solar cells, etc. Recently, plastic materials have attracted attention as an alternative to glass substrates for display devices to satisfy requirements, such as reduction in size, thickness and weight, excellent impact resistance, and flexibility.

Examples of materials recently used as such plastic substrates include polyethylene terephthalate (PET), polyether sulfone (PES), polyethylene naphthalate (PEN), polyarylate (PAR), polycarbonate (PC), polyimide (PI), and the like. However, these materials can cause problems such as deflection of products and disconnection of wiring due to their considerably high coefficients of thermal expansion. In addition, although polyimide resin has a relatively low coefficient of thermal expansion, it is pointed out that the polyimide-based resin is not suitable for substrate materials due to very low transparency, high birefringence and moisture absorption.

To solve these problems, Japanese Patent Publication No. 2004-51960A discloses a transparent composite optical sheet made of an alicyclic epoxy resin containing an epoxy group, a bisphenol A epoxy resin, an acid anhydride curing agent, a catalyst, and glass fiber cloths.

Further, Japanese Patent Publication No. 2005-146258A discloses a transparent composite optical sheet made of an alicyclic epoxy resin containing an ester group, an epoxy resin with a dicyclopentadiene skeleton, an acid anhydride curing agent, and glass fiber cloths, and Japanese Patent Publication No. 2004-233851A discloses a transparent substrate made of a bisphenol A epoxy resin, a bisphenol A novolac epoxy resin, an acid anhydride curing agent, and glass fiber cloths.

However, the composite sheets disclosed in these patents have a glass transition temperature (Tg) within the range of 145° C. to 160° C., which is lower than a process temperature employed during manufacture of the same, and thus have low heat resistance and deteriorated processibility.

In order to increase the glass transition temperature (Tg) of a composite sheet, a method of introducing a bulky aromatic structure into a binder has been proposed. However, in this case, the sheet has reduced flexibility and becomes rigid and thus may not be suitable for flexible substrates. In addition, due to increased viscosity, the sheet is deteriorated in solubility and wettability, and becomes brittle.

Therefore, there is a need for a novel composite sheet that has improved heat resistance without deterioration in flexibility and exhibits excellent wetting properties to glass fibers.

### DISCLOSURE

### [Technical Problem]

One aspect of the present invention is to provide a composite sheet having excellent properties in terms of flexibility, transparency and heat resistance, while ensuring excellent resistance to impact, tension, and bending.

Another aspect of the present invention is to provide a composite sheet having a low coefficient of thermal expansion and excellent light transmittance.

A further aspect of the present invention is to provide a composite sheet which has low viscosity, thereby providing excellent processibility and wettability in preparation of a glass fiber composite.

Yet another aspect of the present invention is to provide a composite sheet which does not have a glass transition temperature (Tg) within a process temperature range, thereby providing excellent heat resistance.

Yet another aspect of the present invention is to provide a composite sheet enabling adjustment of curing rate.

Yet another aspect of the present invention is to provide a display substrate enabling reduction in size, thickness, weight and cost using the composite sheet.

### [Technical Solution]

One aspect of the present invention relates to a composite sheet. The composite sheet includes an oxetane-(meth)acrylate compound, represented by

Formula 1, as a binder:

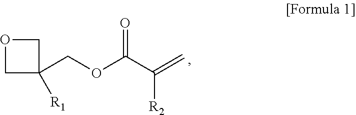

wherein R₁ is hydrogen, a methyl group or an ethyl group, and R₂ is hydrogen or a methyl group.

The composite sheet may include a binder including the oxetane-(meth)acrylate compound, and a glass filler. In one embodiment, the composite sheet includes 100 parts by weight of the binder and about 40 parts by weight to about 300 parts by weight of the glass filler, preferably about 60 parts by weight to about 250 parts by weigh of the glass filler.

The glass filler may include at least one selected from the group consisting of glass fibers, glass fiber cloths, glass fabrics, non-woven glass fabrics, glass meshes, glass beads, glass powders, and glass flakes.

In one embodiment, the binder may further include a cationic polymerizable compound.

The cationic polymerizable compound may include at least one selected from the group consisting of epoxy group-containing compounds, oxetane group-containing compounds, vinyl ether group-containing compounds, and caprolactam group-containing compounds.

The difference in refractive index between the binder and the glass filler may be about 0.01 or less.

The oxetane-(meth)acrylate compound, represented by the Formula 1, may have a molecular weight/equivalent weight of a reactive functional group of about 110 g/eq or less, preferably about 100 g/eq or less.

In one embodiment, the composite sheet may further include a cationic initiator.

In one embodiment, the composite sheet may have a glass transition temperature of about 150° C. or more, for example about 175° C. or more, preferably about 200° C. or more. In another embodiment, the composite sheet may exhibit no glass transition point at about 250° C. or less (Tg-less properties). Another aspect of the present invention relates to a display substrate including the composite sheet.

In one embodiment, the substrate has a coefficient of thermal expansion (al) of about 30 ppm/° C. or less, preferably about 20 ppm/° C. or less, as measured using a TMA at 5° C./min from 30° C. to 250° C.

### [Advantageous Effects]

The composite sheet according to the present invention has excellent flexibility, transparency and heat resistance while ensuring excellent impact resistance, tensile strength, bending resistance, etc. In addition, the composite sheet has a low coefficient of thermal expansion and excellent light transmittance. Further, the composite sheet has low viscosity, thereby providing excellent processibility in preparation of a glass fiber composite. Furthermore, the composite sheet permits adjustment of curing rate. A display substrate including the composite sheet permits reduction in size, thickness, weight, and cost.

### DESCRIPTION OF DRAWINGS

FIG. 1 shows a TMA graph of a composite sheet prepared in Example 1.

FIG. 2 shows a TMA graph of the composite sheet prepared in Example 1 after heat treatment.

FIG. 3 shows a TMA graph of a composite sheet prepared in Comparative Example 2.

FIG. 4 shows a TMA graph of the composite sheet prepared in Comparative Example 2 after heat treatment.

### BEST MODEL

One aspect of the present invention relates to a composite sheet. The composite sheet includes a binder and a glass filler.

The binder includes an oxetane-(meth)acrylate compound represented by Formula 1:

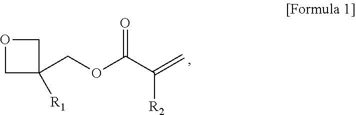

wherein R₁ is hydrogen, a methyl group or an ethyl group, and R₂ is hydrogen or a methyl group.

As shown in Formula 1, the oxetane-(meth)acrylate compound according to the present invention has an asymmetric structure of a single oxetane group at one terminal thereof and a double bond at the other terminal thereof. The oxetane-(meth)acrylate compound has a low molecular weight, thereby increasing a concentration of reactive functional groups within the composite sheet. This leads to high cross-linking density in curing and thus increases hardness, thereby providing improved heat resistance and exhibiting no inflection point of glass transition temperatures at about 250° C. or less. In addition, in the case of using such an oxetane-(meth)acrylate compound as a binder, the binder has excellent mechanical properties and low viscosity, thereby providing outstanding processibility for the preparation of a glass fiber composite.

In one embodiment, the oxetane-(meth)acrylate compound of Formula 1 may be prepared by reacting oxetane alcohol with (meth)acryloyl chloride. Here, the reaction temperature may range from about −10° C. to about 20° C.

In one embodiment, the binder may include the oxetane-(meth)acrylate compound of Formula 1 alone. In another embodiment, the binder may further include a mixture of the oxetane-(meth)acrylate compound of Formula 1 and other resins in order to match the refractive index of the binder with that of glass fibers. For example, the binder may further include a cationic polymerizable compound together with the oxetane-(meth)acrylate compound.

The cationic polymerizable compound may include epoxy group-containing compounds, oxetane group-containing compounds, vinyl ether group-containing compounds, caprolactam group-containing compounds, and the like, without being limited thereto. Examples of the cationic polymerizable compound may include glycidyl epoxy resins such as a bisphenol A epoxy resin, bisphenol F epoxy resin, and bisphenol S epoxy resin; 2-hydroxyethyl vinyl ether; diethylene glycol monovinyl ether; 4-hydroxybutyl vinyl ether; diethylene glycol vinyl ether; triethylene glycol divinyl ether; cyclohexanedimethanol divinyl ether; cyclohexanedimethanol monovinyl ether; tricyclodecane vinyl ether; cyclohexyl vinyl ether; methoxyethyl vinyl ether; ethoxyethyl vinyl ether; and tetravinyl ether of pentaerythritol.

The cationic polymerizable compound may be present in an amount of about 99 wt % or less, for example, about 0.01 wt % to about 95 wt %, in the binder. The cationic polymerizable compound is preferably present in an amount of about 1 wt % to about 75 wt %, more preferably about 3 wt % to about 70 wt %, still more preferably about 5 wt % to about 65 wt %, in the binder. Within this range, the refractive index of the binder can match that of the glass fibers, thereby producing a composite sheet having excellent transparency and light transmittance.

In one embodiment, a weight ratio of the oxetane-(meth)acrylate compound of Formula 1 to the cationic polymerizable compound may range from about 1:0.05 to about 1:4. Within this range, the binder has excellent heat resistance and permits preparation of a light-transmitting film as the refractive index thereof matches that of the glass fiber. The weight ratio of the oxetane-(meth)acrylate compound to the cationic polymerizable compound preferably ranges from 1:0.1 to 1:3.5, more preferably from 1:0.5 to 1:3.

In one embodiment, the difference in refractive index between the binder and the glass filler is about 0.01 or less. In the case of glass fibers having a diameter of 100 nm or more, light scattering at an interface of the glass fibers can cause transmittance reduction. To prevent such transmittance reduction, a difference in refractive index between the binder and the glass filler is about 0.01 or less. The difference in refractive index therebetween is preferably about 0.0001 to 0.007, more preferably about 0.0005 to 0.005. Within this range, the composite sheet can achieve excellent transparency and transmittance.

In one embodiment, the binder may have a transmittance of about 80% to about 99%, preferably about 85% to about 95%. Within this range, the composite sheet can achieve excellent transparency and display quality.

In addition, the binder may have a coefficient of thermal expansion of about 20 ppm/° C. or less, preferably about 0.01 ppm/° C. to about 15 ppm/° C. Within this range, suitable heat resistance for a substrate can be secured.

The oxetane-(meth)acrylate compound of Formula 1 is a bifunctional compound and may have a molecular weight/equivalent weight of the reactive functional group of about 110 g/eq or less, preferably about 100 g/eq or less. Such a low molecular weight/equivalent weight of the reactive functional group allows the binder to have a high cross-linking density.

Examples of the glass filler may include glass fibers, glass fiber cloths, glass fabrics, non-woven glass fabrics, glass meshes, glass beads, glass powders, and glass flakes, without being limited thereto. These glass fillers may be used alone or in combination thereof. Preferably, the glass filler is in sheet form, such as glass fiber cloths, glass fabrics, non-woven glass fabrics, glass meshes, etc.

The glass filler may be present in an amount of about 40 parts by weight to about 300 parts by weight based on 100 parts by weight of the binder. Within this range, CTE properties suitable for a substrate can be ensured. Preferably, the glass filler is present in an amount of about 60 parts by weight to about 250 parts by weight based on 100 parts by weight of the binder.

In one embodiment, the composite sheet may further include a cationic initiator. The cationic initiator may include onium-based cationic curing catalysts, aluminum chelate-based cationic curing catalysts, and the like. Examples of the cationic initiator may include an aromatic sulfonium salt, an aromatic iodonium salt, an ammonium salt, an aluminum chelate complex, a boron trifluoride amine complex, etc. The aromatic sulfonium salt may include, for example, hexafluoroantimonate salt; the aluminum chelate complex may include, for example, aluminum ethylacetoacetate diisopropylate and aluminum tris(ethylacetoacetate);

and the boron trifluoride amine complex may include, for example, a boron trifluoride monoethylamine complex, a boron trifluoride imidazole complex, and a boron trifluoride piperidine complex. These cationic initiators may be used alone or in combination thereof. The cationic initiator may be present in an amount of about 0.01 parts by weight to about 10 parts by weight, preferably about 0.05 parts by weight to about 5 parts by weight, based on 100 parts by weight of the binder. Within this range, curing reaction of the composite composition can be sufficiently accomplished.

The composite sheet of the present invention may further include antioxidants, UV absorbers, dyes, pigments, coupling agents, other inorganic fillers, and the like, as needed.

The composite sheet of the present invention may be prepared in sheet form by impregnating binder components within the glass filler, followed by cross-linking. The sheet may have a thickness from about 50 μm to about 200 μm, preferably from about 70 μm to about 150 μm.

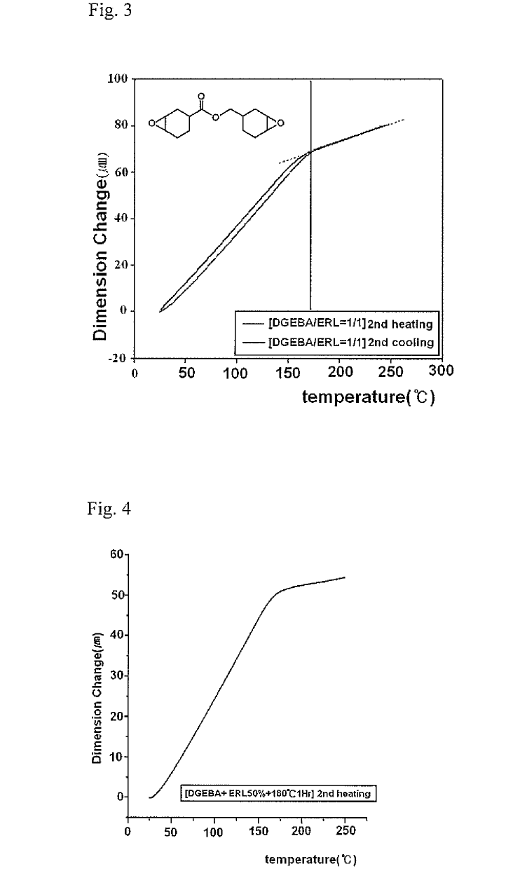

In one embodiment, the composite sheet may have a glass transition temperature of about 150° C. or more, for example about 175° C. or more, more preferably about 200° C. or more. In another embodiment, the composite sheet may exhibit no glass transition point at about 250° C. or less (Tg-less properties). As used herein, the expression “no glass transition point (Tg-less properties)” means that an inflection point does not appear in data on temperature-dimension change (μm) measured using a TMA (thermo-mechanical analyzer). As shown in FIG. 3, a composite sheet including a conventional binder has an inflection point at 170° C. in TMA data. In contrast, the composite sheet of the present invention does not have any inflection point within the same temperature range. As such, the absence of glass transition point in the process temperature range can ensure excellent heat resistance without deterioration in flexibility. In addition, use of the oxetane-(meth)acrylate compound of the present invention as a binder, due to its non aromatic properties and low molecular weight, can result in maintenance of low viscosity, provides excellent wetting properties in preparation of a composite sheet.

Another aspect of the invention relates to a display substrate including the composite sheet. The display substrate may be used as a substrate for display and optical devices, such as liquid crystal display devices (LCDs), color filters, organic EL display devices, solar cells, touch screen panels, etc.

In this case, the composite sheet may further include a hard coat layer, a gas barrier layer, and the like on at least one side thereof. A process of forming these layers can be readily performed by those skilled in the art.

The display substrate may have a coefficient of thermal expansion (al) of not more than about 30 ppm/° C., preferably not more than about 20 ppm/° C., as measured by a TMA at 5° C./min from 30° C. to 250° C.

For instance, if the binder is present in an amount of about 60 wt % in the composite sheet, the coefficient of thermal expansion (al) may range from about 20 ppm/° C. to about 25 ppm/° C. In another embodiment, if the binder is present in an amount of about 40 wt % in the composite sheet, the coefficient of thermal expansion (al) may range from about 10 ppm/° C. to about 15 ppm/° C. In still another embodiment, if the binder is present in an amount of not more than about 30 wt % in the composite sheet, the coefficient of thermal expansion (al) may be less than about 10 ppm/° C.

The substrate may have a transmittance of about 80% or more, preferably about 85% or more, more preferably about 86% or more at a wavelength of 550 nm. Now, the present invention will be described in more detail with reference to some examples. However, it should be noted that these examples are provided for illustration only and are not to be construed in any way as limiting the present invention.

Descriptions of details apparent to those skilled in the art will be omitted for clarity.

### MODE FOR INVENTION

### EXAMPLES

### Preparative Example 1

### Preparation of Oxetane-Methacrylate

Oxetane alcohol (I eq., 5 g, 0.05 mol) and 4-(dimethylamino)pyridine (1 mol %, 60 mg) were stirred in 100 ml of methylene chloride at room temperature for 5 minutes. After decreasing the temperature of the mixture to 0° C., Et3N (2 eq., 10 g, 0.1 mol) was slowly added to the mixture, and methacryloyl chloride (2eq, 10.5 g, 0.1 mol) was slowly added dropwise to the resulting material for 10 minutes, followed by stirring at room temperature for 2 hours. After completion of reaction, a NaHCO₃ solution was added to the resulting material, which in turn was stirred for 20 minutes, followed by work up with water and salt water. MgSO₄ was added to an organic layer, and the resultant was isolated by filtering, followed by removal of the solvent therefrom using an evaporator and column purification, thereby preparing oxetane-methacrylate.

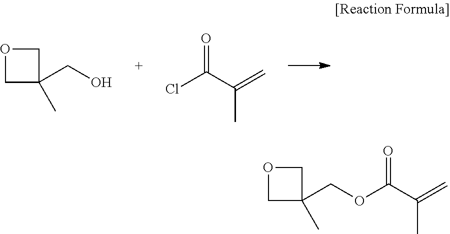

### Example 1

### Preparation of Composite Sheet

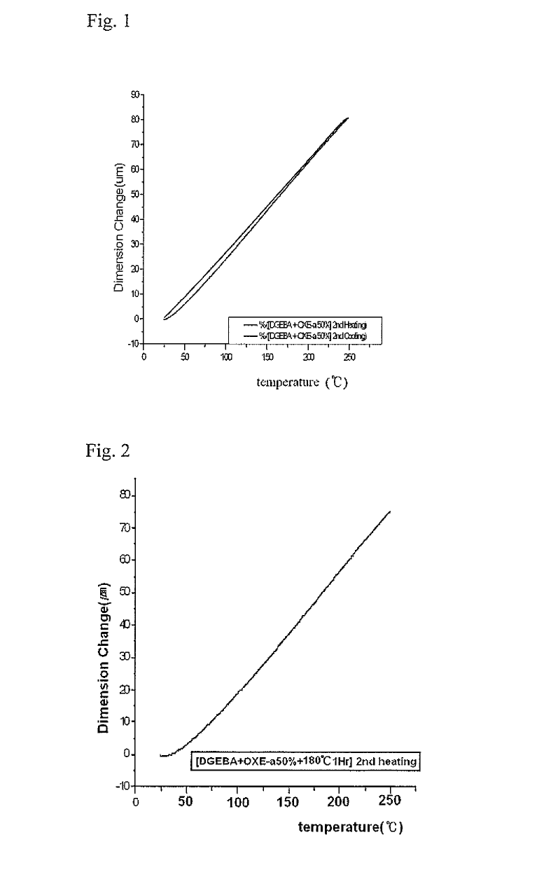

4.9 g of oxetane-methacrylate obtained in Preparative Example 1, 5.1 g of diglycidyl ether of bisphenol A, and 0.2 g of a triarylsulfonium hexafluoroantimonate salt were sufficiently mixed. After impregnating the mixture with 10 g of E-glass based glass fibers (Product 3313, Nittobo Co. Ltd.), the resultant was placed between release-treated glass substrates and both sides of the substrate were UV irradiated for 2 minutes, thereby producing a transparent composite sheet (resin content: 50 wt %) having a binder content of 50 wt %. FIG. 1 shows a TMA graph of the prepared composite sheet, and FIG. 2 shows a TMA graph of the composite sheet after heat treatment at 180° C. for 1 hour.

### Comparative Example 1

A transparent composite sheet was prepared in the same manner as in Example 1 except that (3-methyloxetan-3-yl)methanol, that is, a monofunctional oxetane represented by Formula 2, was used instead of the oxetane-methacrylate obtained in Preparative Example 1. The resultant composite sheet had too low hardness, making it difficult to form a film.

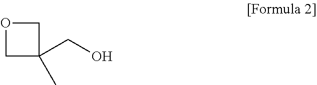

### Comparative Example 2

A transparent composite sheet was prepared in the same manner as in Example 1 except that 7-oxa-bicyclo[4.1.0]heptan-3-ylmethyl7-oxa-bicyclo[4.1.0]heptane-3-carboxylate, that is, a di-functional epoxy represented by Formula 3, was used instead of the oxetane-methacrylate obtained in Preparative Example 1. FIG. 3 shows a TMA graph of the prepared composite sheet, and FIG. 4 shows a TMA graph of the composite sheet after heat treatment at 180° C. for 1 hour.

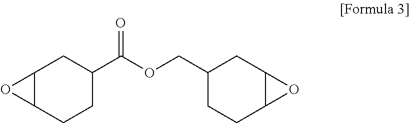 [SMILES: O=C(OCC1CCC2OC2C1)C1CCC2OC2C1]

The transparent composite sheets prepared in Example 1 and Comparative Examples 1 and 2 were evaluated as to properties as follows. Results are shown in Table 1.

(1) Light Transmittance: Light transmittance (%) at a wavelength of 550 nm was evaluated using a UV-Vis spectrometer.

(2) Coefficient of Thermal Expansion (CTE) and Glass Transition Temperature (Tg): Dimensional change according to temperature was measured using a thermo-mechanical analyzer (Expansion mode, Force 0.05N), and then CTE (ppm/° C.) and glass transition temperature (° C.) of samples were obtained from a sample length variation curve according to temperature.

TABLE 1

| | | | CTE (ppm/° C.) | | Molecular |
|---|---|---|---|---|---|
| | | | @ 50~150° C. | | weight/equivalent |
| | Light | CTE | After heat | | weight of reactive |
| | Transmittance | (ppm/° C.) | treatment | | functional groups |
| | @ 550 nm | @ 50~250° C. | (180° C., 1 hr) | Tg (° C.) | (g/eq) |
| Example 1 | 89% | 13 | 13 | Tg-less | 92 |
| | | | | transition | |
| Comparative | Impossible to | — | — | — | 102 |
| Example 1 | form | | | | |
| | composite | | | | |
| | film | | | | |
| Comparative | 88% | 14 | 16 | 170° C. | 126 |
| Example 1 | | @ 30~150° C. | @ 30~150° C. | | |

As shown in Table 1, it can be seen that the composite sheet prepared in Example 1 maintained initial strength and properties even at a polymer decomposition temperature (at 350° C. or more), thereby not undergoing glass transition. Conversely, the composite sheet of Comparative Example 1 had too low hardness to form a film, and the composite sheet of Comparative Example 2 was increased in coefficient of thermal expansion after heat treatment and had a glass transition temperature of 170° C. Therefore, it could be confirmed that, the composite sheet, including the oxetane-(meth)acrylate compound as a binder, according to the present invention has excellent heat resistance properties.

Although some embodiments have been described herein, it will be understood by those skilled in the art that these embodiments are provided for illustration only, and various modifications, changes, alterations and equivalent embodiments can be made without departing from the scope of the present invention. Therefore, the scope and sprit of the present invention should be defined only by the accompanying claims and equivalents thereof.

1. A composite sheet comprising: an oxetane-(meth)acrylate compound represented by Formula 1, as a binder: 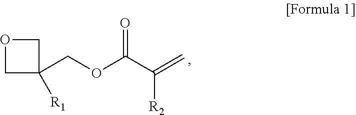
wherein R₁ is hydrogen, a methyl group or an ethyl group, and R₂ is hydrogen or a methyl group.

2. The composite sheet according to claim 1, comprising: a binder comprising the oxetane-(meth)acrylate compound, and a glass filler.

3. The composite sheet according to claim 2, comprising: 100 parts by weight of the binder and about 40 parts by weight to about 300 parts by weight of the glass filler.

4. The composite sheet according to claim 2, wherein the glass filler comprises at least one selected from the group consisting of glass fibers, glass fiber cloths, glass fabrics, non-woven glass fabrics, glass meshes, glass beads, glass powders, and glass flakes.

5. The composite sheet according to claim 2, wherein the binder further comprises a cationic polymerizable compound.

6. The composite sheet according to claim 5, wherein the cationic polymerizable compound comprises at least one selected from the group consisting of epoxy group-containing compounds, oxetane group-containing compounds, vinyl ether group-containing compounds, and caprolactam group-containing compounds.

7. The composite sheet according to claim 2, wherein a difference in refractive index between the binder and the glass filler is about 0.01 or less.

8. The composite sheet according to claim 2, further comprising: a cationic initiator.

9. The composite sheet according to claim 1, wherein the composite sheet has a glass transition temperature of about 175° C. or more.

10. The composite sheet according to claim 1, wherein the composite sheet has a glass transition temperature of about 250° C. or more.

11. A display substrate comprising the composite sheet according to claim 1.

12. The display substrate according to claim 11, wherein the display substrate has a coefficient of thermal expansion of about 30 ppm/° C. or less, as measured using a TMA at 5° C./min from 30° C. to 250° C.
